(19) United States
(12) Patent Application Publication
(10) Pub. No.: US 2017/0082254 A1
(43) Pub. Date: Mar. 23, 2017

(54) SPOTLIGHT

(71) Applicant: Gemmy Industries Corp., Coppell, TX (US)

(72) Inventor: Cheng-Chun Zhang, Shenzhen City (CN)

(73) Assignee: Gemmy Industries Corp., Coppell, TX (US)

(21) Appl. No.: 15/341,730

(22) Filed: Nov. 2, 2016

Related U.S. Application Data
(63) Continuation-in-part of application No. 15/200,291, filed on Jul. 1, 2016.
Application No. 15/200,291 is a continuation of application No. 14/145,512, filed on Dec. 31, 2013.

(51) Int. Cl. F21S 10/00; F21V 21/08; F21S 8/00; F21V 15/01; F21V 23/02

(52) U.S. Cl. CPC F21S 10/007; F21V 15/01; F21V 23/02; F21S 8/032; F21V 21/0824; F21W 2121/00

(57) ABSTRACT

A spotlight includes a housing defining an interior space and having an open front, the housing including a cover mounted to the open front, the cover being substantially transparent or translucent; a motor located in the interior space of the housing, the motor including an output shaft; a light module located in the interior space of the housing, the light module having multiple light units facing toward the cover, wherein the output shaft of the motor projects through the light module. The spotlight further includes a first lens mounted on the light module, wherein the output shaft of the motor projects through the first lens; and a second lens mounted to the output shaft of the motor, wherein rotation of the output shaft of the motor rotates the second lens with respect to the first lens and the light module. Other embodiments and features are also described.

### CROSS-REFERENCE TO RELATED APPLICATIONS

This application is a continuation-in-part of U.S. application Ser. No. 15/200,291, filed on Jul. 1, 2016, which is a continuation of U.S. application Ser. No. 14/145,512, filed on Dec. 31, 2013. The entire contents of the foregoing applications is hereby incorporated herein by reference.

### BACKGROUND

1. Technical Field

The present invention relates to a spotlight, and more particularly, to a spotlight that can project a whirling and/or drifting visual effect.

2. Description of Related Art

A conventional spotlight has a housing and a cover that together house a light module and a film. The light module may include multiple lights that direct light through the film. The film has a decorative pattern formed thereon. In use, light projects from the light units through the film and toward the cover, thereby projecting the decorative pattern of the film.

### SUMMARY

According to an embodiment, a spotlight comprises: a housing defining an interior space and having an open front, the housing including a cover mounted to the open front, the cover being substantially transparent or translucent; a motor located in the interior space of the housing, the motor including an output shaft; a light module located in the interior space of the housing, the light module having multiple light units facing toward the cover, wherein the output shaft of the motor projects through the light module; a first lens mounted on the light module, wherein the output shaft of the motor projects through the first lens; and a second lens mounted to the output shaft of the motor, wherein rotation of the output shaft of the motor rotates the second lens with respect to the first lens and the light module.

According to another embodiment, a spotlight comprises: a housing defining an interior space and having an open front, the housing including a cover mounted to the open front, the cover being substantially transparent or translucent; a power supply located within the housing; a motor located in the interior space of the housing, the motor including an output shaft; a light module located in the interior space of the housing, the light module including a circuit board and a plurality of light units mounted on a side of the circuit board facing toward the cover, wherein the output shaft of the motor projects through a bore in the circuit board; a first lens located between the light module and the cover, wherein the output shaft of the motor projects through a bore in the first lens, the first lens including a plurality of cone protrusions protruding toward the light module, the plurality of cone protrusions corresponding in position to the plurality of light units; and a second lens mounted to the output shaft of the motor, wherein rotation of the output shaft of the motor rotates the second lens with respect to the first lens and the light module.

Further objectives and advantages, as well as the structure and function of preferred embodiments, will become apparent from a consideration of the description, drawings, and examples.

### BRIEF DESCRIPTION OF THE DRAWINGS

The foregoing and other features and advantages of the invention will be apparent from the following, more particular description, as illustrated in the accompanying drawings wherein like reference numbers generally indicate identical, functionally similar, and/or structurally similar elements.

FIG. 1 is a perspective view of a spotlight according to an embodiment of the present invention.

FIG. 2 is an exploded perspective view of the spotlight of FIG. 1.

FIG. 3 is a side, partial cross-sectional view of the spotlight of FIG. 1.

FIG. 4 is a partial front view of the spotlight of FIG. 1.

### DETAILED DESCRIPTION

Embodiments of the invention are discussed in detail below. In describing embodiments, specific terminology is employed for the sake of clarity. However, the invention is not intended to be limited to the specific terminology so selected. While specific embodiments are discussed, it should be understood that this is done for illustration purposes only. A person skilled in the relevant art will recognize that other components and configurations can be used without departing from the spirit and scope of the invention.

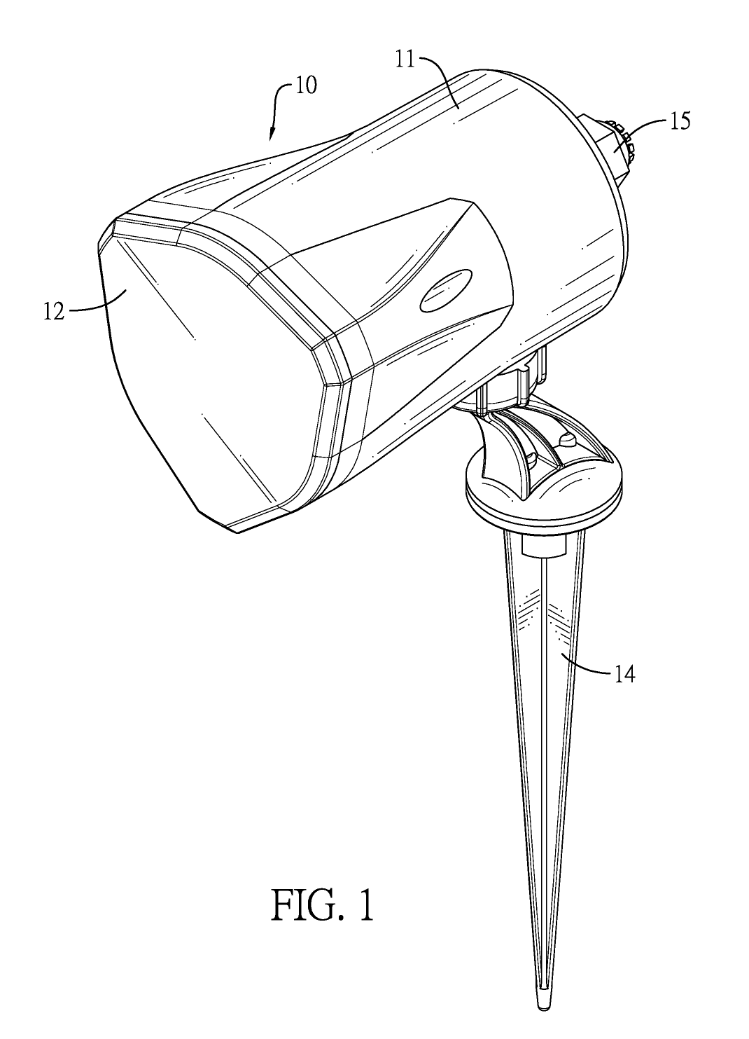

With reference to FIGS. 1 to 3, an embodiment of a spotlight is shown. The spotlight can include one or more of a housing 10, a power supply 20, a driving module 30, a light module 40, a first lens 50, a second lens 60, and a film 70.

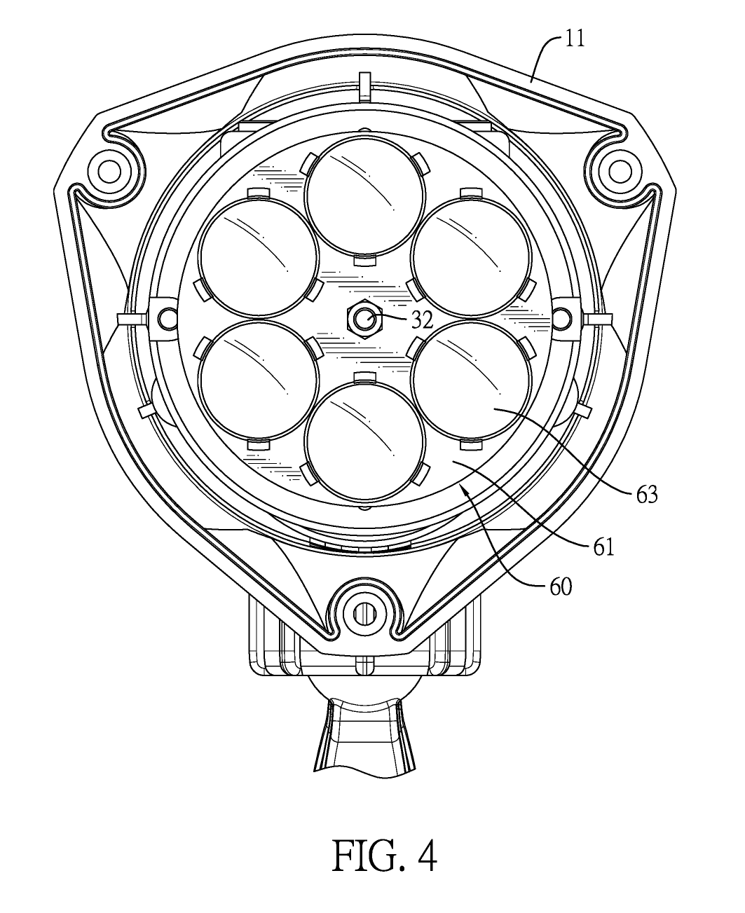

The housing 10 can be formed partially or entirely of plastic, metal, or other suitably rigid material. The housing 10 can include a light base 11, a cover 12 of transparent or translucent material, and a sealing ring 13 or gasket disposed between the light base 11 and cover 12. A stake-portion or grounding stick 14 can be mounted to a bottom portion of the light base 11, and can be used, for example, to secure the spotlight in the ground. The grounding stick 14 can be coupled to the housing 10 in a pivotable manner as can be seen, for example, by the ball-and-socket connection shown in FIG. 4. The housing 10 can further include a cable fixing unit 15 and a bar 16. The light base 11 defines an inner space. The cover 12 is mounted over an open front portion of the light base 11. The cable fixing unit 15 can be mounted on a rear of the light base 11, and can be used to secure/seal a power cable connected with the spotlight. The bar 16 is mounted in the light base 11.

The power supply 20 can be located entirely or partially in the inner space of the light base 11. The power supply 20 can include a cable box 21 and a power board 22 mounted in the cable box 21. The power board 22 can be electrically connected with a cable extending through the cable fixing unit 15 to the exterior of the spotlight, for example, to be connected with a conventional 110V AC power receptacle. Although not specifically shown, in an alternate embodiment, the power board 22 can be electrically connected to a conventional light-bulb “base” (such as a threaded base) so that the spotlight can be connected directly to the socket of an existing lighting fixture.

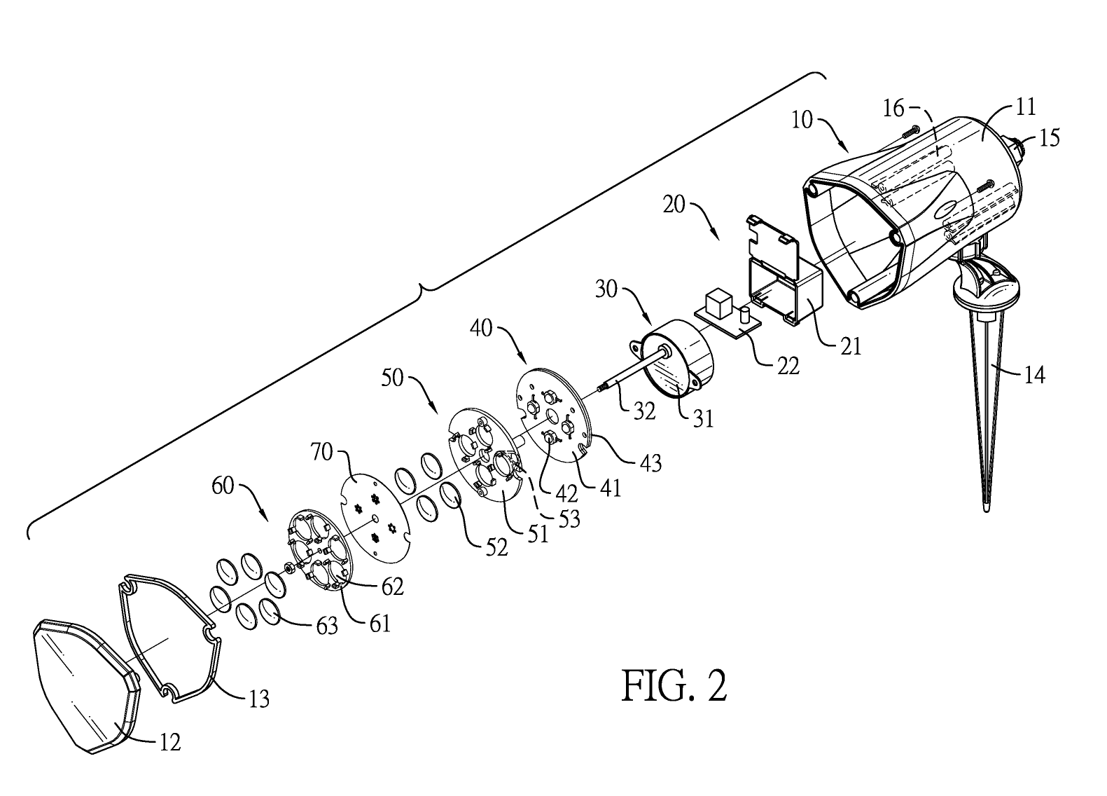

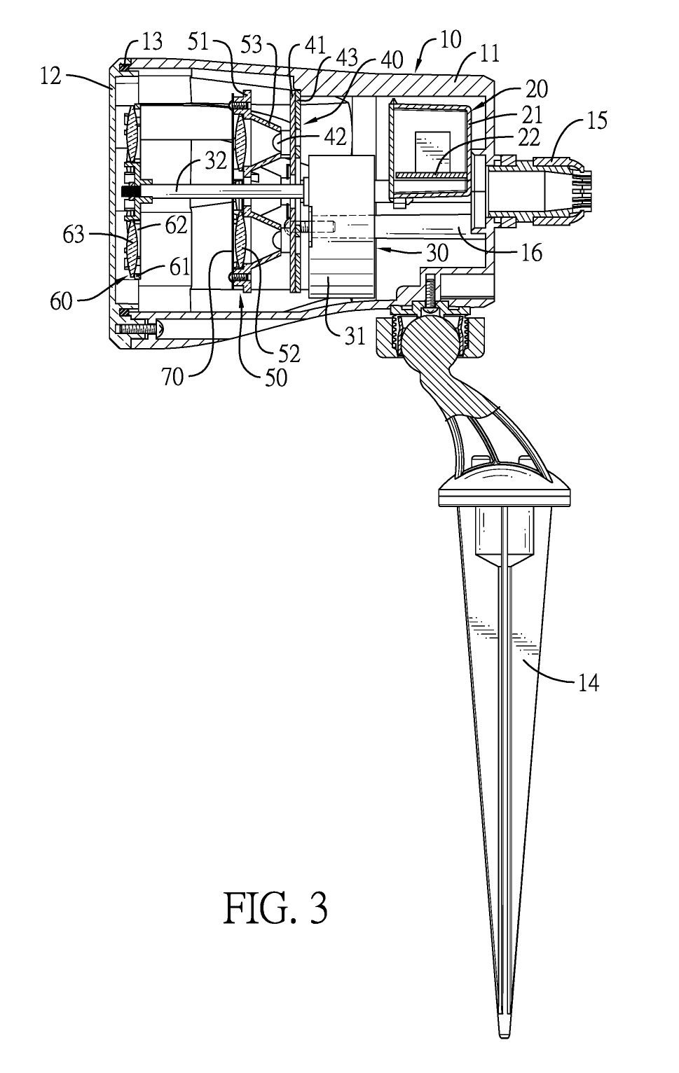

Referring to FIGS. 2 and 3, the driving module 30 is located in the inner space of the light base 11, and can be electrically connected with the power supply 20 (e.g. via wires or other conductors), such that the power supply 20 provides electric power to the components of the driving module 30. The driving module 30 can include a motor 31 having an output shaft 32 that is driven by the motor 31. The light module 40 can be mounted in the inner space of the light base 11. The output shaft 32 of the motor 31 can extend through the light module 40, for example, through a bore located in the light module 40, permitting the output shaft 32 to rotate while the light module 40 remains stationary within the light base 11. The light module 40 can be is electrically connected with the power supply 20 (e.g. views or other conductors) so that the power supply 20 provides electric power to the components of the light module 40. The light module 40 can include a circuit board 41, one or more light units 42, and a heat dissipation plate 43 or heat sink. As mentioned above, the circuit board 41 can be mounted around the shaft 32 of the motor 31, for example, via a bore located in the circuit board. The light units 42 are mounted on a side of the circuit board 41 and face toward the cover 12. The light units 42 may be light-emitting diodes (LEDs), laser diodes (LDs) or other types of lights known in the art. The heat dissipation plate 43 can be mounted to the side of circuit board 41 opposite of the light units 42, as shown in FIG. 2. According to an embodiment, the light module 40 has four light units 42, however, embodiments can have more or less than four light units 42.

Still referring to FIGS. 2 and 3, the first lens 50 is mounted inside the light base 11 and in front of the light module 40. According to embodiments, the first lens 50 can be can be attached, directly or indirectly, to the light module 40. The motor's output shaft 32 can extend through the first lens 50, for example, through a bore extending through the first lens 50, to permit the output shaft 32 to rotate while the first lens 50 remains stationary within the light base 11. The first lens 50 can include a first lens support 51 and multiple first lenses, e.g., first convex lenses 52. The first lens 50 can further include multiple cone protrusions 53 extending rearward from the first lens support 51. The cone protrusions 53 can correspond in position to the light units 42, such that a cup body 53 is located in registry with each of the light units 42.

Referring to FIG. 3, each cup body 53 can include an inlet and an outlet formed through opposite ends of the cup body 53. Each of the light units 42 can be inserted into the inlet of one of the cone protrusions 53. Each of the first convex lenses 52 can be mounted in the outlet of one of the cone protrusions 53. According to an embodiment, the first lens 50 has four cone protrusions 53 and four first convex lenses 52, however, other amounts of cone protrusions 53 and first convex lenses 52 are possible.

Referring again to FIGS. 2 and 3, the second lens 60 is mounted in the inner space of the light base 11. The second lens 60 can have a second lens support 61 and multiple second lenses mounted thereon, such as second convex lenses 63. The second lens support 61 can be mounted to the output shaft 32 of the motor 31, for example, such that rotation of the output shaft 32 imparts corresponding rotation to the second lens support 61. The second lens support 61 can include multiple mounting holes 62 extending therethrough, for example, for mounting the second convex lenses 63. According to an embodiment, the second lens 60 has for or six of the second convex lenses 63, however, different amounts of the second convex lenses 63 are possible. Still referring to FIGS. 2 and 3, film 70 is mounted inside the light base 11 between the first lens 50 and the second lens 60. According to embodiments, the film 70 can be mounted to the first lens 50, e.g., directly onto the face of the first lens 50 facing the cover 12. The film 70 can extend around the output shaft 32 of the motor 31, for example, the film 70 can have a bore through which the shaft 32 extends, to permit the output shaft 32 to rotate with respect to the film 70. The film 70 may have one or more decorative patterns formed thereon, such as an image of a snowflake, butterfly, bat, skull, spider, and/or ghost, and/or combinations thereof. For example, the film 70 may be substantially opaque (e.g., black) with clear or translucent colored patterns formed thereon. According to an embodiment, the decorative pattern includes four snowflake images. According to another embodiment, the decorative pattern includes a bat image, a skull image, a spider image, and a ghost image.

In use, motor 31 can be operated to rotate the output shaft 32, which in turn rotates the second lens 60 with respect to the film 70, first lens 50, and light module 40. At the same time, the light units 42 can be illuminated to project lights through the first convex lenses 52 and the decorative patterns on the film 70 toward the rotating second convex lenses 63 to produce a projecting visual effect. According to an embodiment where the second lens 60 has six second convex lenses 63, the projecting visual effect may resemble snowflakes drifting in the sky. According to an embodiment where the second lens 60 has four second convex lenses 63, the projecting visual effect may resemble snowflakes gathering inward and then expanding outward. Therefore, by adjusting the number of the second convex lenses 63, various different projecting visual effects can be produced.

The spotlight can be connected to a source of alternating current, for example, via the power cable or light-bulb base associated with the power supply 20 as described herein above. The power supply can comprise an AC/DC power supply. Accordingly, the alternating current from the source can be transmitted to the power board 22, and then the power board 22 can convert the alternating current into a direct current. Then, the power board 22 can provide the direct current to the light units 42 and/or the motor 31. The motor 31 can thus drive the output shaft 32 to rotate. According to an alternative embodiment, the motor 31 and/or light units 42 can operate based on the AC power provided by the source.

With reference to FIG. 4, the second lens 60 can be rotated by the output shaft 32 of the motor 31. With reference to FIG. 3, the lights projected by the light units 42 can sequentially pass through the cone protrusions 53, the first convex lenses 52, the film 70, the second convex lenses 63, and the cover 12, after which the lights are projected into the ambient environment.

The cone protrusions 53 can condense the light emitted by the light units 42. Each of the first convex lenses 52 can gather the light emitted by the corresponding light unit 42, such that the light from the light units 42 are transformed into parallel light beams after passing through the first convex lenses 52. The second convex lenses 63 can be used for imaging. After the lights pass through the film 70 and the second convex lens 63, the lights can form a real image.

According to embodiments, the light units 42 can emit lights in different colors. For example, one or more of the light units 42 can emit light of a different color than the remainder of the light units 42. Alternatively, individual light units 42 can alter the color of the light it emits. After the lights pass through the second convex lens 63, the decorative patterns on the film 70 can be projected onto a screen with the rotation of the second convex lenses 63 to provide an aesthetic visual effect (e.g., a whirling effect). According to embodiments, the sealing ring 13 can provide a water-proof seal to the light base 11 and cover 12, such that the housing 10 is waterproof. Accordingly, embodiments of the spotlight can be used in an outdoor environment.

According to embodiments, the spotlight can be used as a stand-alone unit. Alternatively, the spotlight can be mounted onto various types of inflatable clothing. Alternatively, the spotlight can be mounted onto various dolls or toys.

From the above description, it is noted that embodiments of the spotlight can have one or more of the following characteristics: lights from the light module 40 can sequentially pass through the cone protrusions 53, the first convex lenses 52, the film 70, the second convex lenses 63, and the cover 12; the cone protrusions 53 can enhance the concentration of the lights; the first convex lenses 53 can provide a condensing effect for the lights; the second convex lenses 63 can facilitate imaging of the lights; therefore, the light can be projected to a relative far distance by the first lens 50 and the second lens 60.

The embodiments illustrated and discussed in this specification are intended only to teach those skilled in the art the best way known to the inventors to make and use the invention. Nothing in this specification should be considered as limiting the scope of the present invention. The various features described herein can be used interchangeably with one another. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A spotlight comprising:
a housing defining an interior space and having an open front, the housing including a cover mounted to the open front, the cover being substantially transparent or translucent;
a motor located in the interior space of the housing, the motor including an output shaft;
a light module located in the interior space of the housing, the light module having multiple light units facing toward the cover, wherein the output shaft of the motor projects through the light module;
a first lens mounted on the light module, wherein the output shaft of the motor projects through the first lens; and
a second lens mounted to the output shaft of the motor, wherein rotation of the output shaft of the motor rotates the second lens with respect to the first lens and the light module.

2. The spotlight of claim 1, wherein the first lens includes a plurality of first convex lenses.

3. The spotlight of claim 1, wherein the second lens includes a plurality of second convex lenses.

4. The spotlight of claim 1, further comprising a film located between the first lens and the second lens.

5. The spotlight of claim 4, wherein the film includes a decorative pattern formed thereon.

6. The spotlight of claim 5, wherein the decorative pattern includes a bat image, a skull image, a spider image, and a ghost image

7. The spotlight of claim 1, wherein the first lens includes a first lens support, and a plurality of cone protrusions each located in registry with one of the light units.

8. The spotlight of claim 7, wherein each of the cone protrusions includes an inlet, and one of the light units is inserted into each of the inlets.

9. The spotlight of claim 7, wherein the first lens includes a plurality of first convex lenses, and each of the cone protrusions includes an outlet with one of the plurality of first convex lenses mounted therein.

10. The spotlight of claim 1, wherein the second lens includes a second lens support defining a plurality of mounting holes.

11. The spotlight of claim 10, further comprising a plurality of second convex lenses, wherein one of the plurality of second convex lenses is mounted in each of the plurality of mounting holes.

12. The spotlight of claim 1, further comprising a power supply located in the interior space of the housing, wherein the motor and the lighting module are each electrically connected with the power supply.

13. The spotlight of claim 12, wherein the power supply comprises an AC/DC power supply.

14. The spotlight of claim 1, wherein the light module further comprises a circuit board, and the light units are mounted on the circuit board.

15. The spotlight of claim 14, wherein the output shaft of the motor projects through a bore in the circuit board.

16. The spotlight of claim 1, wherein the first lens has four first convex lenses, and the second lens has six second convex lenses.

17. The spotlight of claim 1, wherein the light units comprise LEDs or LDs.

18. A spotlight, comprising:
a housing defining an interior space and having an open front, the housing including a cover mounted to the open front, the cover being substantially transparent or translucent;
a motor located in the interior space of the housing, the motor including an output shaft;
a light module located in the interior space of the housing, the light module including a circuit board and a plurality of light units mounted on a side of the circuit board facing toward the cover, wherein the output shaft of the motor projects through a bore in the circuit board;
a first lens located between the light module and the cover, wherein the output shaft of the motor projects through a bore in the first lens, the first lens including a plurality of cone protrusions protruding toward the light module, the plurality of cone protrusions corresponding in position to the plurality of light units; and
a second lens mounted to the output shaft of the motor, wherein rotation of the output shaft of the motor rotates the second lens with respect to the first lens and the light module.

19. The spotlight of claim 18, wherein the first lens includes a plurality of first convex lenses mounted to a first lens support.

20. The spotlight of claim 18, wherein the second lens includes a plurality of second convex lenses mounted to a second lens support.

21. The spotlight of claim 18, wherein the plurality of light units comprise a plurality of LEDs.

22. The spotlight of claim 18, wherein the plurality of light units comprise a plurality of LDs.

23. The spotlight of claim 26, wherein the power supply is an AC/DC power supply.

24. The spotlight of claim 26, wherein the motor is electrically connected to the power supply.

25. The spotlight of claim 26, wherein the light module is electrically connected to the power supply.

26. The spotlight of claim 18, further comprising a power supply located within the housing.
